(19) United States
(12) Patent Application Publication
(10) Pub. No.: US 2025/0375703 A1
(43) Pub. Date: Dec. 11, 2025

(54) ADAPTIVE MECHANISM FOR VIRTUAL ASSET DOWNLOAD

(71) Applicant: Roblox Corporation, San Mateo, CA (US)

(72) Inventor: Addison Polcyn, San Francisco, CA (US)

(73) Assignee: Roblox Corporation, San Mateo, CA (US)

(21) Appl. No.: 18/735,614

(22) Filed: Jun. 6, 2024

(51) Int. Cl. A63F 13/52; G06T 13/40; G06T 17/20

(52) U.S. Cl. CPC A63F 13/52; G06T 13/40; G06T 17/20

(57) ABSTRACT

Implementations described herein relate to methods, systems, and computer-readable media for queuing of virtual assets. In some implementations, the method may include initiating, by a processor, a virtual-asset traffic flow associated with first virtual assets and a plurality of other traffic flows associated with the virtual experience in which an avatar associated with a client device participates. The method may include implementing, by the processor, a delay-based control mechanism for the virtual-asset traffic flow and a congestion-control mechanism for the plurality of other traffic flows. The method may include causing, by the processor, a concurrent download to the client device of a subset of the first virtual assets based on the delay-based control mechanism and information associated with the plurality of other traffic flows based on the congestion-control mechanism.

### TECHNICAL FIELD

Embodiments relate generally to online virtual experience platforms, and more particularly, to methods, systems, and computer readable media to adaptively download virtual assets.

### BACKGROUND

Online platforms, such as virtual experience platforms and online gaming platforms, can include various techniques to download virtual assets to a client device to render such virtual assets as part of a virtual experience.

Modern three-dimensional (3D) game worlds use a large number of virtual assets to provide a high level of immersion. These non-temporal virtual assets include sounds, images, meshes, text, videos, and animations. Notably, even when compressed, the storage space needed for these virtual assets can vary substantially based on their size, intricacy, and quality. The inherent bulk of these files makes their transmission over the internet resource intensive. Considering the diverse and ever-changing landscape of global network performance, where users might toggle between wired, cellular, and Wi-Fi networks, downloading virtual assets might range from nearly instantaneous to prolonged periods, spanning hours.

Existing techniques to download virtual assets suffer from various challenges. For instance, virtual environments usually juggle multiple concurrent traffic flows, each with its own latency demands. These traffic flows may include real-time flows pertaining to avatar position, game physics, or voice communication. While these flows are consistent and typically light on bandwidth, they coexist with other flows in the often congested space of internet traffic. Given the internet's intrinsic “best effort” delivery design, these disparate traffic flows usually compete for space within the same network buffer.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Aspects of this disclosure are directed to methods, systems, and computer readable media to adaptively download virtual assets.

According to one aspect of the present disclosure, a computer-implemented method to adaptively download virtual assets of a virtual experience is provided. The method may include initiating, by a processor, a virtual-asset traffic flow associated with first virtual assets and a plurality of other traffic flows associated with the virtual experience in which an avatar associated with a client device participates. The method may include implementing, by the processor, a delay-based control mechanism for the virtual-asset traffic flow and a congestion-control mechanism for the plurality of other traffic flows. The method may include causing, by the processor, a concurrent download to the client device of a subset of the first virtual assets based on the delay-based control mechanism and information associated with the plurality of other traffic flows based on the congestion-control mechanism.

In some implementations, implementing the delay-based control mechanism for the virtual-asset traffic flow may include determining, by the processor, the subset of the first virtual assets based on one or more of a game-play characteristic, a virtual-asset characteristic, or a connection characteristic of a network connection between the client device and a remote server from which the first virtual assets are downloaded.

In some implementations, the game-play characteristic may include one or more of avatar position, avatar orientation, avatar velocity, avatar audibility, or avatar visibility.

In some implementations, the virtual-asset characteristic may include one or more of: asset size or asset type. In some implementations, the asset type includes a mesh asset, a texture asset, an audio asset, video asset, character asset, object asset, font asset, animation asset, user interface (UI) asset.

In some implementations, the connection characteristic of the network connection may include a transition from a first radio access technology (RAT) to a second RAT different than the first RAT, a packet error rate (PER) meeting a PER threshold, or an average packet delay meeting a packet-delay threshold.

In some implementations, each asset in the first virtual assets is associated with a respective engagement metric, and determining the subset of the first virtual assets may include selecting, by the processor, the subset of the first virtual assets associated with game play based on the respective engagement metric for each asset.

In some implementations, implementing the delay-based control mechanism for the virtual-asset traffic flow may include obtaining, by the processor, engagement data from a plurality of avatars in the virtual experience. In some implementations, implementing the delay-based control mechanism for the virtual-asset traffic flow may include generating, by the processor, the respective engagement metric for each asset in the first virtual assets based on the engagement data from the plurality of avatars.

In some implementations, implementing the delay-based control mechanism for the virtual-asset traffic flow may include, in response to two virtual assets having a same engagement metric that indicates a same length of engagement, causing, by the processor, a virtual asset of the two virtual assets with a smaller data size to be downloaded first.

In some implementations, the method may include determining, by the processor, that a download of a particular virtual asset of the first virtual assets or the subset of the first virtual assets is incomplete at a time the particular virtual asset is requested for game rendering. In some implementations, in response to determining that the download of the particular virtual asset is incomplete, the method may include causing, by the processor, an approximation of the particular virtual asset to be rendered based on at least one characteristic with at least one previously downloaded virtual asset.

According to another aspect of the present disclosure, a computing device is provided. The computing device may include a processor and a memory coupled to the processor, with instructions stored thereon that, when executed by the processor, cause the processor to perform operations. The operations may include initiating a virtual-asset traffic flow associated with first virtual assets and a plurality of other traffic flows associated with the virtual experience in which an avatar associated with a client device participates. The operations may include implementing a delay-based control mechanism for the virtual-asset traffic flow and a congestion-control mechanism for the plurality of other traffic flows. The operations may include causing a concurrent download to the client device of a subset of the first virtual assets based on the delay-based control mechanism and information associated with the plurality of other traffic flows based on the congestion-control mechanism.

In some implementations, implementing the delay-based control mechanism for the virtual-asset traffic flow may include determining the subset of the first virtual assets based on one or more of a game-play characteristic, a virtual-asset characteristic, or a connection characteristic of a network connection between the client device and a remote server from which the first virtual assets are downloaded.

In some implementations, the game-play characteristic may include one or more of avatar position, avatar orientation, avatar velocity, avatar audibility, or avatar visibility.

In some implementations, the virtual-asset characteristic may include one or more of: asset size or asset type. In some implementations, the asset type includes an audio asset, video asset, character asset, or object asset.

In some implementations, the connection characteristic of the network connection may include a transition from a first RAT to a second RAT different than the first RAT, a PER meeting a PER threshold, or an average packet delay meeting a packet-delay threshold.

In some implementations, each asset in the first virtual assets is associated with a respective engagement metric, and determining the subset of the first virtual assets may include selecting the subset of the first virtual assets associated with game play based on the respective engagement metric for each asset.

In some implementations, implementing the delay-based control mechanism for the virtual-asset traffic flow may include obtaining engagement data from a plurality of avatars in the virtual experience. In some implementations, implementing the delay-based control mechanism for the virtual-asset traffic flow may include generating the respective engagement metric for each asset in the first virtual assets based on the engagement data from the plurality of avatars.

In some implementations, implementing the delay-based control mechanism for the virtual-asset traffic flow may include, in response to two virtual assets having a same engagement metric that indicates a same length of engagement, causing a virtual asset of the two virtual assets with a smaller data size to be downloaded first.

In some implementations, the operations may include determining that a download of a particular virtual asset of the first virtual assets or the subset of the first virtual assets is incomplete at a time the particular virtual asset is requested for game rendering. In some implementations, in response to determining that the download of the particular virtual asset is incomplete, the operations may include causing an approximation of the particular virtual asset to be rendered based on at least one characteristic with at least one previously downloaded virtual asset.

According to a further aspect of the present disclosure, a non-transitory computer-readable medium with instructions stored thereon that, when executed by a processor, cause the processor to perform operations is provided. The operations may include initiating a virtual-asset traffic flow associated with first virtual assets and a plurality of other traffic flows associated with the virtual experience in which an avatar associated with a client device participates. The operations may include implementing a delay-based control mechanism for the virtual-asset traffic flow and a congestion-control mechanism for the plurality of other traffic flows. The operations may include causing a concurrent download to the client device of a subset of the first virtual assets based on the delay-based control mechanism and information associated with the plurality of other traffic flows based on the congestion-control mechanism.

In some implementations, implementing the delay-based control mechanism for the virtual-asset traffic flow may include determining the subset of the first virtual assets based on one or more of a game-play characteristic, a virtual-asset characteristic, or a connection characteristic of a network connection between the client device and a remote server from which the first virtual assets are downloaded.

In some implementations, the game-play characteristic may include one or more of avatar position, avatar orientation, avatar velocity, avatar audibility, or avatar visibility.

In some implementations, the virtual-asset characteristic may include one or more of: asset size or asset type. In some implementations, the asset type includes an audio asset, video asset, character asset, or object asset.

In some implementations, the connection characteristic of the network connection may include a transition from a first RAT to a second RAT different than the first RAT, a PER meeting a PER threshold, or an average packet delay meeting a packet-delay threshold.

In some implementations, each asset in the first virtual assets is associated with a respective engagement metric, and determining the subset of the first virtual assets at the second time may include selecting the subset of the first virtual assets associated with game play at the second time based on the respective engagement metric for each asset.

In some implementations, implementing the delay-based control mechanism for the virtual-asset traffic flow may include obtaining engagement data from a plurality of avatars in the virtual experience. In some implementations, implementing the delay-based control mechanism for the virtual-asset traffic flow may include generating the respective engagement metric for each asset in the first virtual assets based on the engagement data from the plurality of avatars.

In some implementations, implementing the delay-based control mechanism for the virtual-asset traffic flow may include, in response to two virtual assets having a same engagement metric that indicates a same length of engagement, causing a virtual asset of the two virtual assets with a smaller data size to be downloaded first.

In some implementations, the operations may include determining that a download of a particular virtual asset of the first virtual assets or the subset of the first virtual assets is incomplete at a time the particular virtual asset is requested for game rendering. In some implementations, in response to determining that the download of the particular virtual asset is incomplete, the operations may include causing an approximation of the particular virtual asset to be rendered based on at least one characteristic with at least one previously downloaded virtual asset.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIGS. 2A and 2B are a data flow diagram depicting operations to download virtual assets based on a delay-based control mechanism, in accordance with some implementations.

FIG. 3 is a diagram depicting a first example scenario in which a delay-based control mechanism to download virtual assets may be implemented, in accordance with some implementations.

FIG. 4 is a diagram depicting a second example scenario in which a delay-based control mechanism to download virtual assets may be implemented, in accordance with some implementations.

FIG. 5 illustrates a flowchart of an example method to adaptively download virtual assets for a virtual experience, in accordance with some implementations.

FIG. 6 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of 3D avatars that are used in a 3D virtual experience or environment. Some implementations of the techniques described herein may be applied to various types of 3D environments, such as a virtual reality (VR) conference, a 3D session (e.g., an online lecture or other type of presentation involving 3D avatars), a virtual concert, an augmented reality (AR) session, or in other types of 3D environments that may include one or more users that are represented in the 3D environment by one or more 3D avatars.

The present disclosure provides methods, systems, and computer-readable media to implement a congestion-control technique whereby virtual asset download is adaptively deprioritized when the download is being performed at the same as one or more real-time streams e.g., streams that employ delay-based congestion control algorithms. In various implementations, the congestion-control technique may be implemented by an online virtual environment server. The online virtual environment server may cause a first initiate a virtual-asset traffic flow associated with first virtual assets and a plurality of other traffic flows associated with the virtual experience in which an avatar associated with a client device participates. The online virtual environment server may implement a delay-based control mechanism for the virtual-asset traffic flow. To mitigate buffer bloat and/or latency issues, the delay-based control mechanism may include determining a subset of virtual assets to download. The subset of virtual assets to download may be determined based on a manual prioritization, a heuristic prioritization, or a stochastic prioritization. The manual prioritization may include a fixed virtual-asset prioritization that is set manually (e.g., virtual asset A is manually set with the highest prioritization, virtual asset B is manually set with the second highest prioritization, etc.). The heuristics prioritization may include a dynamic virtual-asset prioritization that is selects virtual assets for download based on one or more of, e.g., game-play characteristic, a virtual-asset characteristic, or a connection characteristic of a network connection between the client device and a remote server from which the first virtual assets are downloaded. The stochastic prioritization may include a dynamic virtual-asset prioritization that selects virtual assets for downloads based on, e.g., engagement metrics generated based on a group of players' engagement considering various download orderings. Once determined using one of the prioritizations, the online virtual experience server may cause a concurrent download of the subset of virtual assets and information associated with other traffic flows.

The congestion-control technique can proceed through several stages of increasing complexity and power. This is because a delay-based congestion control mechanism may cause a slowdown in the completion of downloading virtual assets due to potentially lower throughput. The present disclosure also provides various techniques detailed below to provide a virtual experience to a player (associated with an avatar) to compensate for delayed downloads or unavailability of one or more virtual assets.

### System Architecture

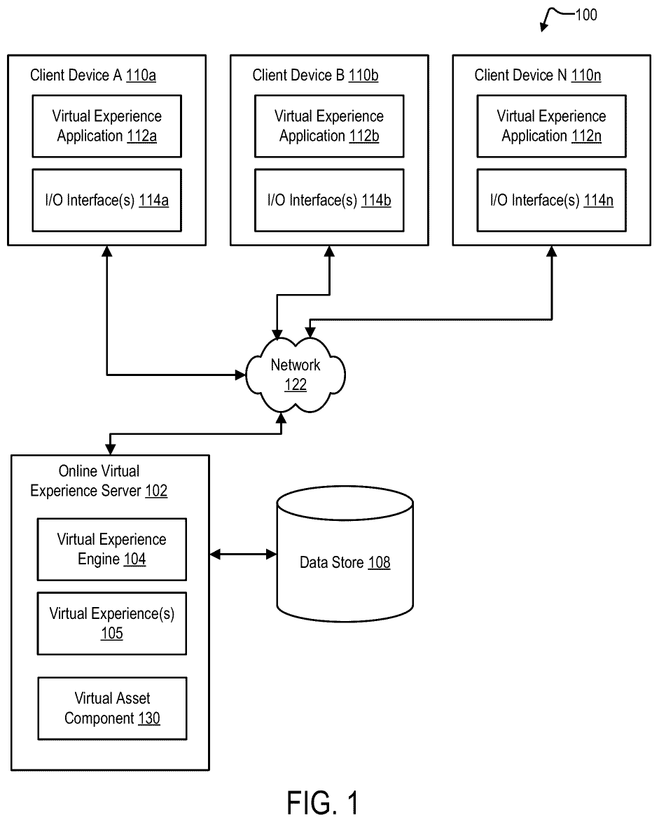

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, and client devices 110, all coupled via a network 122.

The online virtual experience server 102 can include, among other things, a virtual experience engine 104, one or more virtual experiences 105, and a virtual asset component 130. The online virtual experience server 102 may be configured to provide virtual experiences 105 to one or more client devices 110, and to implement the delay-based control mechanism via the virtual asset component 130.

Data store 108 is shown coupled to online virtual experience server 102 but in some implementations, can also be provided as part of the online virtual experience server 102. The data store may, in some implementations, be configured to store advertising data, user data, engagement data, and/or other contextual data in association with the virtual asset component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences.

Network environment 100 is provided for illustration. In various implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network, 5G New Radio (NR)), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the online virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110.

### Example Method

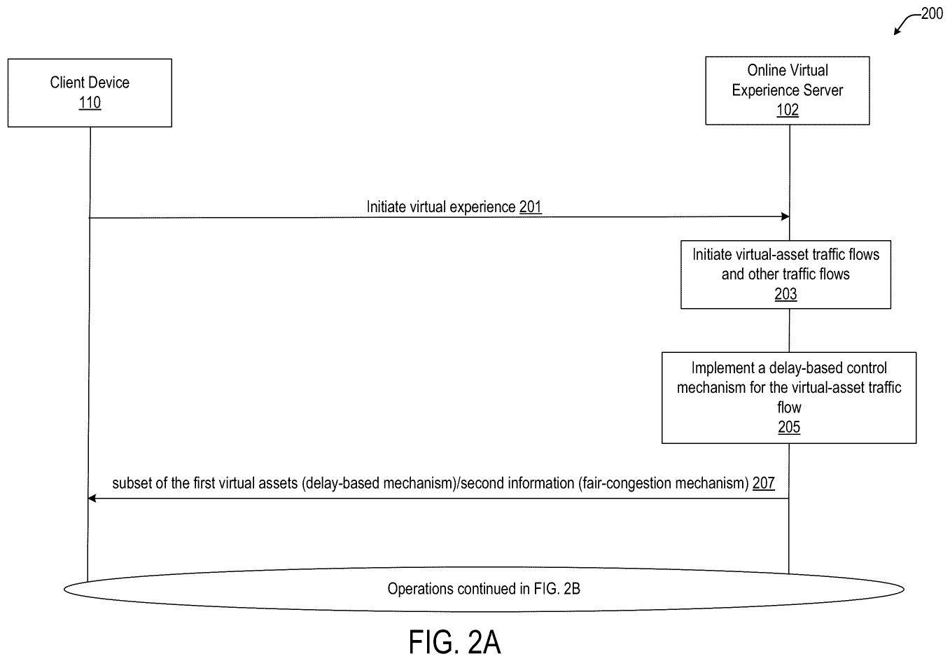

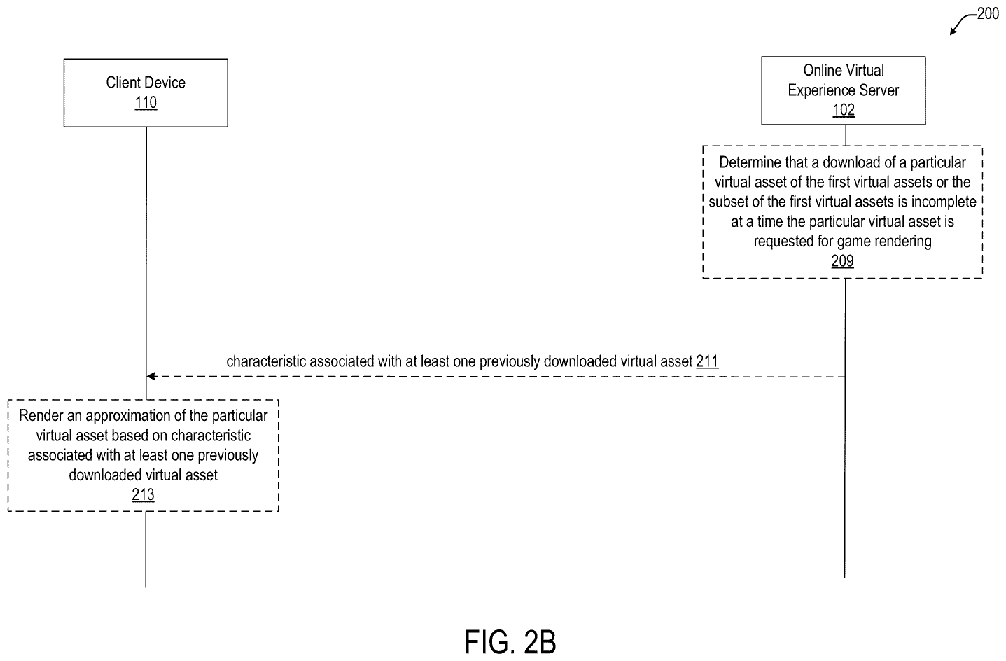

FIGS. 2A and 2B are a data flow diagram depicting operations 200 to download virtual assets based on a delay-based control mechanism, in accordance with some implementations. The operations 200 depicted in FIGS. 2A and 2B may be performed by the online virtual experience server 102 (e.g., the virtual asset component 130) and the client device 110. In FIGS. 2A and 2B, optional operations are indicated with dashed lines.

Referring to FIG. 2A, the client device 110 may send (at 201) a request to initiate a virtual experience to online virtual experience server 102. In response to the request, online virtual experience server 102 may initiate (at 203) a virtual-asset traffic flow associated with first virtual assets and a plurality of other traffic flows associated with the virtual experience in which an avatar associated with a client device participates. For example, online virtual experience server 102 may generate virtual experience instructions for the virtual experience requested by the client device 110. As mentioned above, virtual experience instructions may refer to instructions that allow a client device 110 to render gameplay, graphics, audio, and other features of a virtual experience. The instructions may be associated with a plurality of traffic flows associated with the requested virtual experience. By way of example and not limitation, these traffic flows may include a first traffic flow associated with avatar position, a second traffic flow associated with game/virtual experience physics, a third traffic flow associated with voice communication, a fourth traffic flow associated with download of virtual assets for the virtual experience, etc. Each of the traffic flows may be associated with a respective latency constraint.

While these traffic flows are consistent and typically light on bandwidth, they coexist with other flows in the often congested space of internet traffic. These disparate traffic flows usually compete for space within the same network buffer at the online virtual experience server 102.

Different traffic flows may employ varied congestion-control mechanisms, each tailored to specific performance outcomes. For instance, causing the download of virtual assets may rely on transmission control protocol (TCP) algorithms, which prioritize throughput. However, this peak throughput may lead to bloat buffer queues at the online virtual environment server 102. With other real-time flows also vying for space in these buffer queues, the other traffic flows may suffer from heightened latency when virtual assets are being downloaded. In extreme cases, causing the download of virtual assets may cause buffer bloat at the online virtual environment server 102 and/or at the client device 110. This may jeopardize the performance of the real-time flow e.g., the real-time traffic flow may exhibit problems such as packet loss, increased jitter, and/or latency spikes.

Such a scenario is problematic, particularly when virtual assets for a virtual experience are downloaded asynchronously. A user without high-end network performance (e.g., 5G New Radio (NR), or high-throughput Wi-Fi, etc.) may experience undesirable lags or glitches in gameplay while virtual assets are being downloaded over the network to a client device associated with the user.

To overcome these and other challenges, the online virtual experience server 102 may implement (at 205) a delay-based control mechanism for downloading virtual assets to the client device 110 to mitigate issues such as buffer bloat, among others. The goal of the delay-based control mechanism is to measure the round-trip latency of virtual-asset data packets and the protocol-control message(s) (e.g., acknowledgement (ACK)/negative acknowledgement (NACK) message, etc.) to/from the client device 110, to monitor for latency deltas, and to generate a trendline based on the latency deltas that indicate when a buffer is reaching a threshold capacity. For instance, online virtual experience server 102 may include a time stamp in virtual-asset packets to indicate the time of transmission. At the client device 110, a time stamp may be included in the ACK/NACK response to indicate the time at which the virtual-asset packet was received. Based on the difference in time stamps (e.g., the latency delta), online virtual experience server 102 may generate a trendline to determine when the virtual-asset buffer is likely to reach a threshold amount. The virtual-asset buffer may include a buffer located at one or more of, e.g., client device 110, a router, and/or online virtual experience server 102. Based on the trendline, online virtual experience server 102 may adjust the number or type of virtual assets that are downloaded on the fly to avoid buffer bloat. Various implementations are implemented to ensure that the buffer queue size is maintained within bounds such latency in deep buffers is not impacted.

Because the delay-based control mechanism causes a slower download of virtual assets than the congestion-control mechanism, the online virtual experience server 102 may ensure assets necessary for gameplay for any given scenario within the virtual experience are prioritized for download, as further described below.

For instance, referring to FIG. 2B, to implement (at 205) the delay-based control mechanism, the online virtual experience server 102 may determine a subset of the virtual assets for immediate downloading. The subset of virtual assets may be determined based on one or more of a game-play characteristic, a virtual-asset characteristic, or a connection characteristic of a network connection between the client device and a remote server from which the first virtual assets are downloaded.

In some implementations, the game-play characteristic includes one or more of avatar position, avatar orientation, avatar velocity, avatar audibility, or avatar visibility.

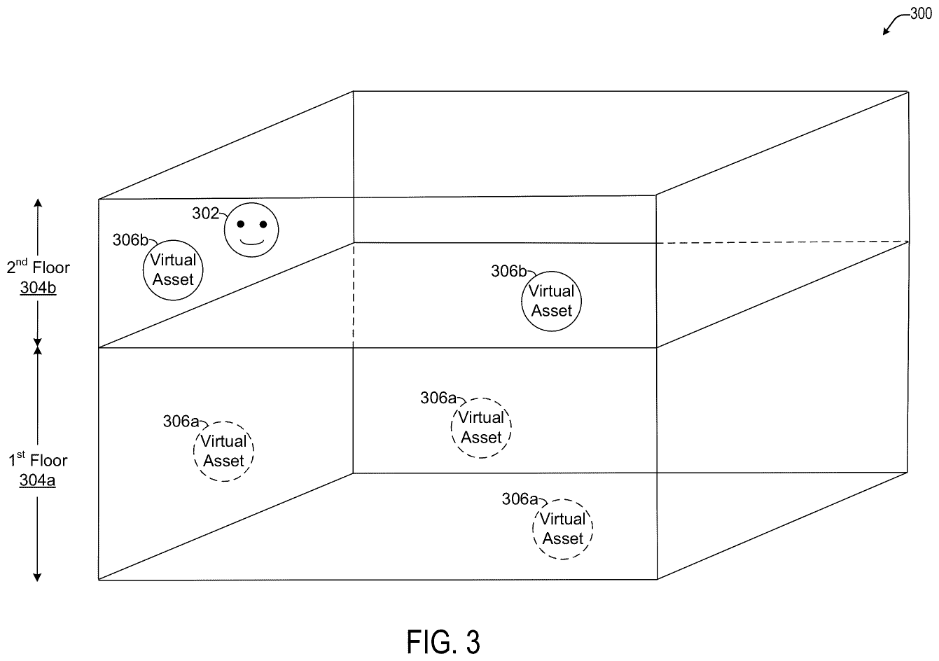

To determine the subset of virtual assets to download based on avatar position, the online virtual experience server 102 may determine which virtual assets enhance the immersive experience of game play at any given moment based on the avatar's position. For example, FIG. 3 depicts a first example scenario 300 in which a delay-based control mechanism for downloading virtual assets may be implemented based on avatar position, in accordance with some implementations.

Referring to FIG. 3, an avatar 302 may enter a virtual experience at a point inside a building (of the virtual experience) on the second floor 304b. Because the avatar 302 is located on the second floor 304b and cannot see the first floor 304a (the floor is non-transparent), the online virtual experience server 102 may cause the virtual assets 306b (e.g., a subset of the virtual assets 306) on the second floor 304b to be downloaded before initiating the download of the virtual assets 306a on the first floor 304a. In some implementations, the virtual assets 306b on the second floor 304b may be identified based on metadata, e.g., such as a location tag.

The present delay-based control mechanism is designed to respond to pause or resume requests automatically. For instance, if the avatar 302 moves to the first floor 304a before the download of the virtual assets 306b on the second floor 304b is completed, the virtual assets 306b remain in the queue. When the avatar 302 moves from the second floor 304b to the first floor 304a, download of the virtual assets 306b on the second floor 304b may be paused, such that the download of the virtual assets 306a on the first floor 304a can immediately begin. In this way, the delay-based control mechanism may mitigate buffer bloat and/or latency issues associated with other traffic flows without negatively impacting the immersive experience of game play.

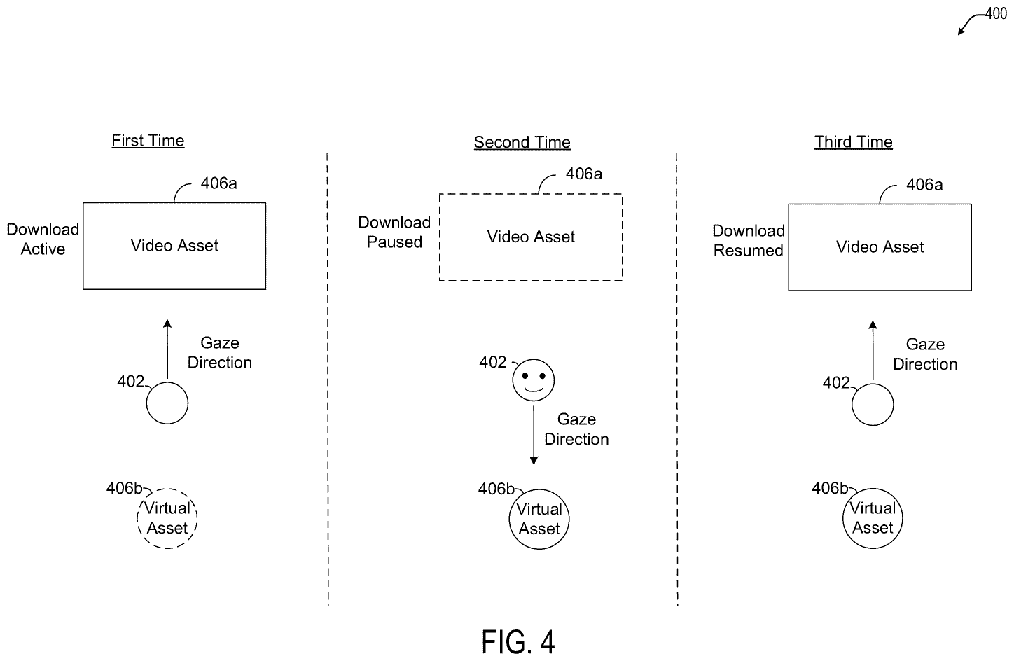

Referring again to FIG. 2A, to determine the subset of virtual assets to download based on avatar orientation, the online virtual experience server 102 may determine which virtual assets enhance the experience of participation in the virtual experience at any given moment based on the avatar's orientation (e.g., gaze direction). For example, FIG. 4 depicts a second example scenario 400 in which virtual assets may be downloaded based on avatar orientation, in accordance with some implementations.

Referring to FIG. 4, at a first time, an avatar 402 is oriented such that its gaze is towards a virtual video asset 406a and away from a static virtual asset 406b. The virtual video asset 406a may include, e.g., an advertisement related or unrelated to the game, a music video, a concert, a sports game, a movie, a television show, etc. The static virtual asset 406b may include, e.g., tree, fire hydrant, stop sign, etc. At the first time, the online virtual experience server 102 may determine the virtual video asset 406a as the subset of virtual video assets and cause the download of a virtual video asset 406a displayed on a virtual video screen. The online virtual experience server 102 may hold off causing download of the static virtual asset 406b at the first time since the asset is determined to be unlikely to be used in rendering the virtual experience at the client device associated with the avatar 402.

At a second time, if the avatar 402 turns away from the virtual video screen before the download of the virtual video asset 406a is complete, the online virtual experience server 102 may pause the download of the virtual video asset 406a. Because the avatar 402 is now oriented such that its gaze is toward the static virtual asset 406b, the online virtual experience server 102 may determine the static virtual asset 406b as the subset of virtual assets and cause the download of the static virtual asset 406b.

At a third time, if the avatar 402 turns its gaze once again toward the virtual video asset 406a, the online virtual experience server 102 may determine the virtual video asset 406a is the subset of virtual assets and resume the download of the virtual video asset 406a. In this way, the delay-based control mechanism may mitigate buffer bloat and/or latency issues associated with other traffic flows without negatively impacting the immersive experience of game play.

Referring again to FIG. 2A, to determine the subset of virtual assets to download based avatar velocity, the online virtual experience server 102 may select the subset of virtual assets to download based on the speed and direction in which an avatar moves. Based on the avatar's velocity, the online virtual experience server 102 may determine the time at which the avatar is likely to be in a position within the virtual experience from where the avatar is able to see/hear/interact with a virtual asset. Hence, the online virtual experience server 102 may select the subset of virtual assets as those assets the avatar is able to see/hear/interact with at any given moment. Those virtual likelihood of being seen/heard/interacted with by the avatar until a later time are excluded from the subset.

In some implementations, the online virtual experience server 102 may assign a likelihood value to each asset in the first virtual assets. A virtual asset may be selected for inclusion in the subset when the likelihood value assigned to the asset meets a threshold. In some instances, the threshold may be predetermined based on a baseline probability of interaction in prior gameplay, e.g., one or more prior gameplay sessions for the virtual experience. In some implementations, the threshold may be determined dynamically, based on network conditions, available network capacity, buffer capacity, asset size, etc. In some other implementations, the likelihood value may vary, depending on network conditions. For instance, under network conditions A, the likelihood value of virtual asset A may be greater than under network conditions B. Thus, under favorable network conditions some virtual assets may be selected for the subset, while the same virtual assets may not be included in the subset under less favorable network conditions. This may because under less favorable network conditions, an avatar may be less likely to interact with that virtual asset due to network lag, among others.

To determine the subset of virtual assets to download based on avatar audibility (whether an asset is likely audible to the avatar), the online virtual experience server 102 may determine the subset of virtual assets to download based on the distance from the avatar's position to various audio sources (associated with audio assets). For instance, avatar audibility may encompass all sound sources that can be heard from the avatar's position. The radio assets included in the subset may be selected as a function of distance and/or asset type. The subset of virtual radio assets may thus be determined based on radio asset type and distance. For instance, a loudspeaker at a first distance from the avatar may be included in the subset but the sound of a river flowing at the first distance may not be included since it is quieter.

To determine the subset of virtual assets to download using avatar visibility (whether an asset is likely visible to the avatar), the online virtual experience server 102 may determine the subset of virtual assets to download at any given time based on a predetermined distance from the avatar's position that virtual assets can be seen and virtual asset size. For instance, avatar visibility may encompass all virtual assets larger than or equal to a first physical size within a first predetermined radius from the avatar's position, all virtual assets larger than or equal to a second physical size within a second predetermined distance, etc. The subset of virtual assets may be determined as those assets within various predetermined radiuses and physical sizes of assets, and which are not occluded. Any asset outside the various predetermined radiuses at that time or which are occluded by other assets are excluded from the subset.

As mentioned above, the online virtual experience server 102 may determine the subset of virtual assets based on a virtual-asset characteristic, e.g., such as asset size (physical size within the virtual experience) or asset type (e.g., static assets, dynamic assets, other avatars, etc.). When asset size is used, the online virtual experience server 102 may determine the subset as those virtual assets with a data size less than a threshold size.

When asset type is used, the online virtual experience server 102 may determine the subset of virtual assets as dynamic assets under some conditions and other avatars under other conditions. For instance, under various network conditions, the online virtual experience server 102 may cause the download of only dynamic virtual assets. Dynamic virtual assets may refer to a video asset, an audio asset, and/or any asset that responds to interactions by the player's avatar. However, when the network conditions worsen, for example, the online virtual experience server 102 may cause the download of only other avatars. The other avatars may be character assets of other avatars within the virtual experience. However, the online virtual experience server 102 may determine the subset of virtual assets includes only static assets, such as objects, plants, buildings, etc., under some conditions.

In some implementations, the online virtual experience server 102 may determine the subset of virtual assets based on a connection characteristic of the network connection between the client device 110 and the online virtual experience server 102. The connection characteristic may include one or more of, e.g., a transition from a first radio access technology (RAT) (e.g., WLAN, WPAN, cellular, LTE, 5G New Radio (NR), etc.) to a second RAT, a packet-error rate (PER) meeting PER threshold, and/or an average packet delay meeting a packet-delay threshold. For example, if the client device 110 is initially connected to network 122 via a WLAN connection and transitions to a cellular connection (e.g., such as when a player leaves home), the online virtual experience server 102 may determine the subset of the virtual assets as those assets that can be downloaded within a latency threshold using the new RAT.

Still referring to FIG. 2A, the online virtual experience server 102 may implement (at 205) the delay-based control mechanism by obtaining engagement data associated with a plurality of avatars in the virtual experience. The online virtual experience server 102 may obtain data (e.g., from data store 108) associated with the length of time an avatar remains engaged with the virtual environment and the order in which virtual assets are downloaded. The order in which virtual assets are downloaded for different players' avatars may be different. Thus, the engagement data for different players' avatars may be associated with different orders of virtual assets downloaded. The online virtual experience server 102 may determine a respective engagement metric for each virtual asset based on the engagement data from the plurality of avatars. In some implementations, the engagement data may be associated with a time period of game play. For instance, when an avatar first enters a virtual experience, the engagement data may indicate that immediately downloading virtual asset A increases a player's engagement with the virtual experience. However, when an avatar has been in the virtual experience for a while, the download of virtual asset A may be less beneficial for retaining a player's engagement. Thus, the engagement data used to select the subset of virtual assets for download may be associated with a duration of game play, in some non-limiting examples.

To determine the subset of virtual assets, the online virtual experience server 102 may select the subset of virtual assets based on the respective engagement metric for each virtual asset. For instance, the subset of virtual assets may include the virtual assets with engagement metrics indicate game-play engagement that meet or exceed a threshold length of time. In some implementations, if two virtual assets are associated with the same length of engagement, the online virtual experience server 102 may select the virtual asset that is closer to the player's avatar, for example. Other conditions may be used to select from multiple virtual assets associated with the same length of engagement without limitation. In some implementations, if two virtual assets are associated with the same length of engagement, the virtual asset that can be downloaded most quickly may be selected ahead of the other virtual asset, in one non-limiting example.

Once the subset of virtual assets is determined, the online virtual experience server 102 may cause (at 207) a concurrent download of a subset of the virtual assets using the delay-based control mechanism and information associated with the other traffic flows using the congestion-control mechanism to the client device 110.

Referring again to FIG. 2B, in some scenarios, the online virtual experience server 102 may determine (at 209) that a virtual asset is necessary for game rendering by the client device 110. When the virtual asset necessary for game rendering is not downloaded in time, the online virtual experience server 102 may identify virtual assets already downloaded by the client device 110 that approximate the virtual asset that is needed but not yet downloaded. For example, assume the client device 110 needs a yellow car driving down the road for gameplay but the download of the yellow car is not yet completed. If there is a yellow flower vase which has already been downloaded from a house scene, the online virtual experience server 102 may determine the texture of the yellow flower vase approximates the texture of the car based on metadata similarity between the yellow car and the yellow vase. In another example, assume a spruce tree was already downloaded but a pine tree is downloading too slowly. Then, the online virtual experience server 102 may determine that the spruce tree mesh can be used to render the pine tree until the pine tree mesh downloads.

Still referring to FIG. 2B, the online virtual experience server 102 may send (at 211) a signal indicating to the client device 110 that the characteristic (e.g., yellow texture of vase) associated with the previously downloaded virtual asset (e.g., the yellow vase) is used to render (at 213) the needed virtual asset (e.g., the yellow car). For instance, the yellow texture of the vase may be made up of yellow shapes of various sizes. Client device 110 may render the car by applying the yellow shapes of various sizes to match the shape of the car's mesh. This may be accomplished by repeating yellow shapes or resizing the yellow shapes to fit over the entirety of the car's mesh, in some non-limiting examples.

The delay-based control mechanism described above with reference to FIGS. 2A and 2B mitigates the buffer-bloat issue at the tradeoff of lower throughput of virtual assets, with an upside of unobstructed real-time other traffic flows.

### Example Method

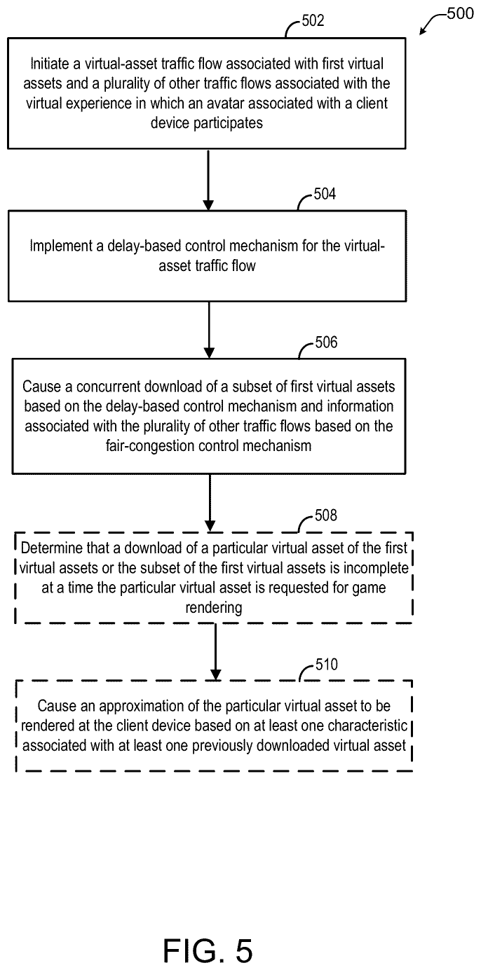

FIG. 5 is a flowchart of a method adaptively downloading virtual assets for a virtual experience, in accordance with some implementations.

In some implementations, method 500 can be implemented, for example, on a server (e.g., online virtual experience server 102) described with reference to FIG. 1. In some implementations, some or all of the method 500 can be implemented on one or more client devices 110 as shown in FIG. 1, on one or more developer devices (not illustrated), or on one or more online virtual experience server(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 500. In some examples, a first device is described as performing blocks of method 500. Some implementations can have one or more blocks of method 500 performed by one or more other devices (e.g., other client devices or server devices) that can send results or data to the first device.

In some implementations, method 500, or portions of the method, can be initiated automatically by a system. In some implementations, the implementing system is a first device. For example, the method (or portions thereof) can be periodically performed, or performed based on one or more particular events or conditions.

Referring to FIG. 5, the operations may begin at block 502. At block 502, a virtual-asset traffic flow associated with first virtual assets and a plurality of other traffic flows associated with the virtual experience in which an avatar associated with a client device participates may be initiated. For example, block 502 may correspond to block 203 in FIG. 2A.

Block 502 may be followed by block 504. At block 504, a delay-based control mechanism for the virtual-asset traffic flow may be implemented. In some implementations, implementing the delay-based control mechanism may include, e.g., determining the subset of the first virtual assets based on one or more of a game-play characteristic, a virtual-asset characteristic, or a connection characteristic of a network connection between the client device and a remote server from which the first virtual assets are downloaded. The game-play characteristic may include one or more of avatar position, avatar orientation, avatar velocity, avatar audibility, or avatar visibility. The virtual-asset characteristic may include one or more of: asset size or asset type, and wherein the asset type includes a mesh asset, a texture asset, an audio asset, video asset, character asset, object asset, font asset, animation assets, user interface (UI) assets. The audio asset may include, e.g., soundtrack assets, sound-effect assets, voice assets, etc. The connection characteristic of the network connection may include, e.g., a transition from a first RAT to a second RAT different than the first RAT, a PER meeting a PER threshold, or an average packet delay meeting a packet-delay threshold. Each asset in the first virtual assets may be associated with a respective engagement metric. In some implementations, determining the subset of the first virtual assets at the second time may include selecting the subset of the first virtual assets associated with game play at the second time based on the respective engagement metric for each asset. In some implementations, implementing the delay-based control mechanism may include, e.g., obtaining engagement data from a plurality of avatars in the virtual experience. In some implementations, implementing the delay-based control mechanism may include, e.g., generating the respective engagement metric for each asset in the first virtual assets based on the engagement data from the plurality of avatars. In some implementations, implementing the delay-based control mechanism may include, e.g., in response to two virtual assets having a same engagement metric that indicates a same length of engagement, causing, by the processor, a virtual asset of the two virtual assets with a smaller data size to be downloaded first. For example, block 504 may correspond to block 205 in FIG. 2A.

Referring again to FIG. 5A, block 504 may be followed by block 506. At block 506, a concurrent download of a subset of the first virtual assets based on the delay-based control mechanism and second information associated with the plurality of other traffic flows based on the congestion-control mechanism may be caused. For example, block 506 may correspond to block 207 in FIG. 2A.

Block 506 may be followed by block 508. At block 508, a download of a particular virtual asset of the first virtual assets or the subset of the first virtual assets may be determined as incomplete at a time the particular virtual asset is requested for game rendering. For example, block 508 may correspond to block 209 in FIG. 2B.

Block 508 may be followed by 510. At block 510, an approximation of the particular virtual asset to be rendered at the client device based on at least one characteristic associated with at least one previously downloaded virtual asset may be caused. For example, block 510 may correspond to one or more of block(s) 211 and 213 in FIG. 2B.

One or more of the aforementioned blocks described with reference to FIG. 5 may be omitted, optional, or performed in a different order without departing from the scope of the present disclosure.

### Computing Devices

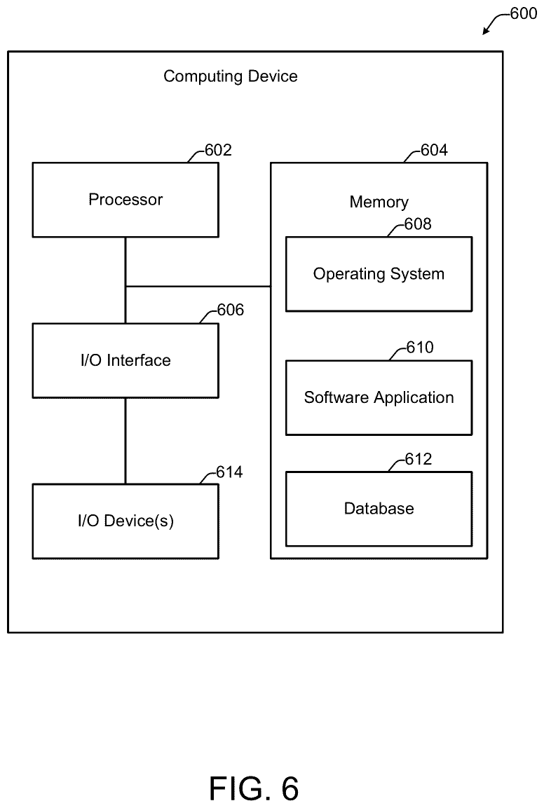

Hereinafter, a more detailed description of various computing devices that may be used to implement different devices and/or components illustrated in FIG. 1 is provided with reference to FIG. 6.

FIG. 6 is a block diagram of an example computing device 600 which may be used to implement one or more features described herein, in accordance with some implementations. In one example, device 600 may be used to implement a computer device, (e.g., 102, 110 of FIG. 1), and perform appropriate operations as described herein. Computing device 600 can be any suitable computer system, server, or other electronic or hardware device. For example, the computing device 600 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 600 includes a processor 602, a memory 604, input/output (I/O) interface 606, and audio/video input/output devices 614 (e.g., display screen, touchscreen, display goggles or glasses, audio speakers, headphones, microphone, etc.).

Processor 602 can be one or more processors and/or processing circuits to execute program code and control basic operations of the device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the computing device 600 by the processor 602, including an operating system 608, software application 610, and associated database 612. In some implementations, the software application 610 can include instructions that enable processor 602 to perform the functions described herein. Software application 610 may include some or all of the functionality used to implement a delay-based control mechanism. In some implementations, one or more portions of software application 610 may be implemented in dedicated hardware such as an application-specific integrated circuit (ASIC), a programmable logic device (PLD), a field-programmable gate array (FPGA), a machine learning processor, etc. In some implementations, one or more portions of software application 610 may be implemented in general purpose processors, such as a central processing unit (CPU) or a graphics processing unit (GPU). In various implementations, suitable combinations of dedicated and/or general purpose processing hardware may be used to implement software application 610.

For example, software application 610 stored in memory 604 can include instructions for implementing a delay-based control mechanism, and/or other functionality or software such as the virtual asset component 130, virtual experience engine 104, and/or virtual experience application 112. Any of software in memory 604 can alternatively be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the computing device 600 with other systems and devices. For example, network communication devices, storage devices (e.g., memory and/or data store 106), and input/output devices can communicate via I/O interface 606. In some implementations, the I/O interface 606 can connect to interface devices including input devices (keyboard, pointing device, touchscreen, microphone, camera, scanner, etc.) and/or output devices (display device, speaker devices, printer, motor, etc.).

For ease of illustration, FIG. 6 shows one block for each of processor 602, memory 604, I/O interface 606, operating system 608, software application 610, and database 612. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the device 600, e.g., processor(s) 602, memory 604, and I/O interface 606. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 614, for example, can be connected to (or included in) the device 600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to adaptively download virtual assets of a virtual experience, the method comprising:
initiating, by a processor, a virtual-asset traffic flow associated with first virtual assets and a plurality of other traffic flows associated with the virtual experience in which an avatar associated with a client device participates;
implementing, by the processor, a delay-based control mechanism for the virtual-asset traffic flow and a congestion-control mechanism for the plurality of other traffic flows; and
causing, by the processor, a concurrent download to the client device of a subset of the first virtual assets based on the delay-based control mechanism and information associated with the plurality of other traffic flows based on the congestion-control mechanism.

2. The method of claim 1, wherein implementing the delay-based control mechanism for the virtual-asset traffic flow comprises:
determining, by the processor, the subset of the first virtual assets based on one or more of a game-play characteristic, a virtual-asset characteristic, or a connection characteristic of a network connection between the client device and a remote server from which the first virtual assets are downloaded.

3. The method of claim 2, wherein the game-play characteristic includes one or more of avatar position, avatar orientation, avatar velocity, avatar audibility, or avatar visibility.

4. The method of claim 2, wherein the virtual-asset characteristic includes one or more of: asset size or asset type, and wherein the asset type includes a mesh asset, a texture asset, an audio asset, video asset, character asset, object asset, font asset, animation asset, user interface (UI) asset.

5. The method of claim 2, wherein the connection characteristic of the network connection comprises:
a transition from a first radio access technology (RAT) to a second RAT different than the first RAT,
a packet error rate (PER) meeting a PER threshold, or
an average packet delay meeting a packet-delay threshold.

6. The method of claim 2, wherein each asset in the first virtual assets is associated with a respective engagement metric, and determining the subset of the first virtual assets comprises selecting, by the processor, the subset of the first virtual assets associated with game play based on the respective engagement metric for each asset.

7. The method of claim 6, wherein implementing the delay-based control mechanism for the virtual-asset traffic flow comprises:
obtaining, by the processor, engagement data from a plurality of avatars in the virtual experience; and
generating, by the processor, the respective engagement metric for each asset in the first virtual assets based on the engagement data from the plurality of avatars.

8. The method of claim 7, wherein implementing the delay-based control mechanism for the virtual-asset traffic flow comprises:
in response to two virtual assets having a same engagement metric that indicates a same length of engagement, causing, by the processor, a virtual asset of the two virtual assets with a smaller data size to be downloaded first.

9. The method of claim 1, further comprising:
determining, by the processor, that a download of a particular virtual asset of the first virtual assets or the subset of the first virtual assets is incomplete at a time the particular virtual asset is requested for game rendering; and
in response to determining that the download of the particular virtual asset is incomplete, causing, by the processor, an approximation of the particular virtual asset to be rendered based on at least one characteristic with at least one previously downloaded virtual asset.

10. A computing device, comprising:
a processor; and
a memory coupled to the processor, with instructions stored thereon that, when executed by the processor, cause the processor to perform operations comprising:
initiating a virtual-asset traffic flow associated with first virtual assets and a plurality of other traffic flows associated with the virtual experience in which an avatar associated with a client device participates;
implementing a delay-based control mechanism for the virtual-asset traffic flow and a congestion-control mechanism for the plurality of other traffic flows; and
causing a concurrent download to the client device of a subset of the first virtual assets based on the delay-based control mechanism and information associated with the plurality of other traffic flows based on the congestion-control mechanism.

11. The computing device of claim 10, wherein implementing the delay-based control mechanism for the virtual-asset traffic flow comprises:
determining the subset of the first virtual assets based on one or more of a game-play characteristic, a virtual-asset characteristic, or a connection characteristic of a network connection between the client device and a remote server from which the first virtual assets are downloaded.

12. The computing device of claim 11, wherein the game-play characteristic includes one or more of avatar position, avatar orientation, avatar velocity, avatar audibility, or avatar visibility.

13. The computing device of claim 11, wherein the virtual-asset characteristic includes one or more of: asset size or asset type, and wherein the asset type includes a mesh asset, a texture asset, an audio asset, video asset, character asset, object asset, font asset, animation asset, user interface (UI) asset.

14. The computing device of claim 11, wherein the connection characteristic of the network connection comprises:
a transition from a first radio access technology (RAT) to a second RAT different than the first RAT,
a packet error rate (PER) meeting a PER threshold, or
an average packet delay meeting a packet-delay threshold.

15. The computing device of claim 11, wherein each asset in the first virtual assets is associated with a respective engagement metric, and determining the subset of the first virtual assets comprises selecting, by the processor, the subset of the first virtual assets associated with game play based on the respective engagement metric for each asset.

16. The computing device of claim 15, wherein implementing the delay-based control mechanism for the virtual-asset traffic flow comprises:
obtaining engagement data from a plurality of avatars in the virtual experience; and
generating the respective engagement metric for each asset in the first virtual assets based on the engagement data from the plurality of avatars.

17. The computing device of claim 16, wherein implementing the delay-based control mechanism for the virtual-asset traffic flow comprises:
in response to two virtual assets having a same engagement metric that indicates a same length of engagement, causing a virtual asset of the two virtual assets with a smaller data size to be downloaded first.

18. The computing device of claim 10, wherein the operations further comprise:
determining that a download of a particular virtual asset of the first virtual assets or the subset of the first virtual assets is incomplete at a time the particular virtual asset is requested for game rendering; and
in response to determining that the download of the particular virtual asset is incomplete, causing an approximation of the particular virtual asset to be rendered based on at least one characteristic with at least one previously downloaded virtual asset.

19. A non-transitory computer-readable medium with instructions stored thereon that, when executed by a processor, cause the processor to perform operations comprising:
initiating a virtual-asset traffic flow associated with first virtual assets and a plurality of other traffic flows associated with the virtual experience in which an avatar associated with a client device participates;
implementing a delay-based control mechanism for the virtual-asset traffic flow and a congestion-control mechanism for the plurality of other traffic flows; and
causing a concurrent download to the client device of a subset of the first virtual assets based on the delay-based control mechanism and information associated with the plurality of other traffic flows based on the congestion-control mechanism.

20. The non-transitory computer-readable medium of claim 19, wherein implementing the delay-based control mechanism for the virtual-asset traffic flow comprises:
determining the subset of the first virtual assets based on one or more of a game-play characteristic, a virtual-asset characteristic, or a connection characteristic of a network connection between the client device and a remote server from which the first virtual assets are downloaded.
